(19) United States
(12) Patent Application Publication
(10) Pub. No.: US 2012/0191478 A1
(43) Pub. Date: Jul. 26, 2012

(54) Insurance Product and Method for Using Same

(76) Inventor: Greg Klement, Prosper, TX (US)

(21) Appl. No.: 13/358,640

(22) Filed: Jan. 26, 2012

Related U.S. Application Data
(60) Provisional application No. 61/436,257, filed on Jan. 26, 2011.

(51) Int. Cl. G06Q 50/24

(52) U.S. Cl. 705/3

(57) ABSTRACT

Embodiments described herein are a method system for providing a medical coverage plan. The method provides a medical coverage plan to a plurality of employees of an entity. The method may determine a geographic location of the entity wherein the geographic location is an area wherein the entity and a majority of the employees for the entity are located. The method may select a plan physician in the geographic location and provide the medical coverage plan to the employees. The method may require the employees covered by the medical coverage plan to have a first medical visit to the plan physician for each medical problem.

### CROSS-REFERENCE TO RELATED APPLICATIONS

This application claims the benefit of U.S. Provisional Application No. 61/436,257 filed Jan. 26, 2011 the disclosure of which is herein incorporated by reference.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### BACKGROUND

The subject matter generally relates to the field of management of medical claims coverage by workers' compensation insurance.

Insurance policies are provided by insurance providers to large national companies. The insurance policies may cover employees located across the country. The employees may visit doctors of their choice at any location across the country. By having multiple doctors across the country in a network, the price of the insurance policy is increased by the lack of certainty in billing of each of the doctors chosen by the employees. In addition, there is a fundamental lack of check and balances against the treatments prescribed by the doctors. There is a need for more efficient and cost effective workers' compensation claims management.

### SUMMARY

Embodiments described herein are a method and/or system for providing a medical coverage system for territorial areas, such as, for example, Texas political subdivisions. More particularly, the embodiments relate to a process, method and/or system for limiting the geographic territory and number of care providers for employees covered by an insurance plan. A workers' compensation plan is provided to a plurality of employees of an entity. A geographic location of the entity is determined wherein the geographic location is an area wherein the entity and a majority of the employees for the entity are located. A plan physician may be selected in the geographic location and the medical workers' compensation benefits may be provided to the employees. The employees covered by the workers' compensation coverage plan may be required to have a first medical visit to the plan physician for each medical problem.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a diagram illustrating a schematic view an insurance system used in a geographic region.

FIG. 2 depicts a diagram illustrating a plan management unit.

FIG. 3 depicts a flow chart depicting a method of using the insurance system.

### DETAILED DESCRIPTION OF THE EMBODIMENT(S) SHOWN

The description that follows includes exemplary apparatus, methods, techniques, and instruction sequences that embody techniques of the present inventive subject matter. However, it is understood that the described embodiments may be practiced without these specific details.

Embodiments described herein comprise an insurance system and method for providing medical insurance network to a political subdivision. The insurance system may have a plan provider that provides coverage to employees of an entity, such as a school district. The coverage may be restricted to a geographic region and limited to a finite number (for example two) plan physicians. The plan physicians may work with the plan provider to minimize medical costs. The employees and the plan physicians may be located in the geographic region in order to minimize costs.

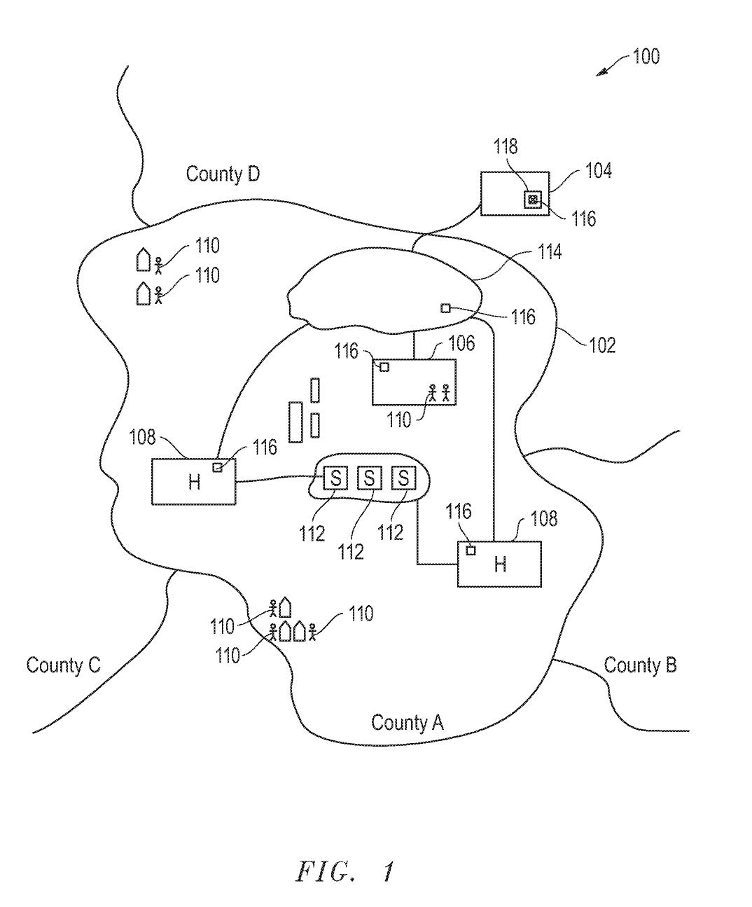

FIG. 1 depicts a schematic view of a workers' compensation medical claim management system (which may be conveniently referred to below as an insurance system) 100. The insurance system 100 may be used at a geographic location 102. The insurance system 100 may include, but is not limited to, a plan provider 104, an entity 106, one or more plan physicians 108, and one or more employees 110 of the entity. The plan provider 104 may provide medical policies, or workers' compensation policies, to one or more entities 106 located in the geographic location 102. The medical policies, or workers' compensation policies, may provide health care coverage to the employees 110 of the entity 106. The medical policy may require the employee 110 to see only the plan physician 108 for all initial consultations. The plan physician 108 may then determine the type of care required for the employee 110 and if a specialist 112 is required. Using only the plan physicians 108 located within the geographic location 102 as the initial contact for employee 110 medical problems may minimize the cost of insurance and the cost of unnecessary peripheral costs such as loss time indemnity claims, overtreatment with unnecessary medical test and rehabilitation, additional overtime required of employees to replace the employee out on leave.

The plan provider 104 may be any political subdivision insurance provider that covers a certain amount of workers' compensation medical expenses of the employees 110 covered by the workers' compensation policy. In return, the plan provider 104 may pay predetermined amounts of money to the plan physician 108 and/or the specialist 112 when health care is provided for the employee 110. The plan provider 104 may collect payments from any number of employees 110 located at any number of entities 106 in the geographic region 102 or around the country (for example the United States). Although, the plan provider 104 may have insurance policies covering multiple entities across the country, each of the insurance policies for each entity 106 may be limited to the geographic location 102 of each entity 102.

The geographic location 102 may be a location that a majority of the entities 106 employees and business takes place. As shown, the geographic location 102 is a county (for example county A) in a state. The entity 106 may only do business, or a majority of its business, in the county. The geographic location 102 may be limited to the location where the entities 102 services are provided. For example, if the entity is a school district, the geographic location 102 may be the extent of the area covered by the school district. Therefore, limiting the insurance policy to the county or geographic location 102, decreases cost to the entity and the plan provider 104 by reducing uncertainty in medical costs. Although the geographic location 102 is described as a county, the geographic location 102 may be any suitable location and/or area including, but not limited to, a city, a town, a village, a township, a parish, a zip code, a state, and the like.

The entity 106 may be any entity having a majority of its business in the geographic location 102. For example, the entity 106 may be a school district. The school district may have several schools, administrative buildings, and facilities located with the geographic location 102. Also, the majority of the employees 110 of the school district (for example: teachers, principals, coaches, and staff) may live in or near the geographic location 102. Having the majority of the employees 110 located proximate the entity 106 and therefore the plan physicians 108 in the geographic location may reduce costs to the entity. Although the entity 106 is described as being a school district it should be appreciated that the entity 106 may be any suitable entity having a majority of its business within the geographic location 102 including, but not limited to, a political subdivision, a municipality, a city, a legislative body, a university, a college, a hospital, a local business, and the like.

In an alternative embodiment, the entity 106 may be a large entity, or multiple political subdivisions, with locations in several geographic regions. In this embodiment, the plan provider 104 may provide several separate regional policies for each of the geographic locations 102 in which the large entity operating.

The employees 110 may be any person who works for the entity 106 and/or may be eligible to join the entities 106 insurance policy. The employees 110 may be direct or contract employees working full time or part time. The employees 110 may also include retired employees, or employees who no longer work for the entity 106.

The plan physicians 108 may be any suitable physician, or doctor, capable of providing medical care to the employees 110. The plan physician 108 may be a general practitioner. The general practitioner may be capable treating and diagnosing multiple medical conditions that the employees 110 may have. The plan physician 108 may treat the employee's 110 condition, or refer the employee to the specialist 112 if other treatment is necessary. For example, the plan physician 108 may refer the employee to an orthopedic doctor, a neurosurgeon, a chiropractor, a physical therapist, and the like. Although the plan physician 108 is described as a general practitioner it should be appreciated that the plan physician 108 may be any suitable medical practitioner capable of meeting and diagnosing the employees 110 including, but not limited to, a specialist, a nurse, a physician's assistant, and the like.

The plan physician 108 may obtain a close relationship with the employees 110 that come for workers' compensation medical care. Because the employees 110 may visit only the plan physicians 108 for their initial treatment, the plan physicians 108 may have a history of treating the patient's specific on the job accident, or conditions. The continued relationship between the plan physician 108 and each of the employees 110 may lower the cost of health care because the plan physician 108 may be able to keep the employee 110. For example, the plan physician may know the employee has a history of an employee's accidents. The physician may be able to spot a trend and relay the information to the political subdivision in an effort to correct a hazardous situation. Therefore, the continued relationship between the plan physician 108 and the employee 110 may reduce medical expenses for the employee 110 and the entity 106.

The plan physician 108 may act as the initial contact for the employees 110 in medical matters. The plan physician 108 may have special discounted rates for the employees 110 covered by the plan provider's 104 medical plan. The special relationship the plan physician 108 has with the plan provider 104 may allow the plan physician to monitor, or police, the amount of care the employee 110 is trying to seek. Further, the plan physician 108 may be a physician who works and/or lives in the geographic location 102. Thus, the plan physician 108 may be personally benefiting from the services provided by the entity 106, or political subdivision. For example, the employee 110 may exaggerate an injury, or illness, in order to draw workers compensation, or medical leave benefits. In the event the employee 110 has a legitimate claim, the plan physician 108 would refer the employee 110 to the proper medical care. However, if the employee 110 is trying to fraudulently obtain the medical care in order to obtain a workers compensation, or medical leave, benefit the plan physician would refuse the treatment and alert the plan provider 104 and/or the entity 106.

The plan physician 108 may work closely with the plan provider 104 in order to lower the medical costs to the entity 106, the employees 110 and the plan provider 104. The costs may be lowered by any suitable method including, but not limited to, fixing the plan physician's 108 fee per visit, recommending preventative medical measures, monitoring false claims, and the like.

A communication network 114 may be provided to allow the plan provider 104, the entity 106, the plan physicians 108, the employees 110 and/or the specialist 112 to communicate with one another using the insurance system 100. The communication network 114 may be any suitable communication device, system or combination thereof. For example, the communication network 114 may be phone lines, wired, wireless, fiber optics, infrared, a local area network (LAN), a personal area network (PAN), and/or a wide area network (WAN). The connection may be made via the communication network 114 to an external computer (for example, through the Internet using an internet service provider) and the like.

A plan management unit 116 may allow the plan provider 104 to manage each of the insurance policies any number of entities 106. The plan management unit 116 may be used in conjunction with the insurance system 100. The plan management unit 116 may be located at the plan provider's 104 place of business, or on a computer 118 used by the plan provider 100. Further, portions of the plan management unit 116 may be located wholly, or partially, at any suitable location such as at the entity 106, at the plan physician's 108 office, the specialist 112 office, the employee's 110 home or office, on the internet, in the communication network 114 and the like.

The plan management unit 116 may take the form of an entirely hardware embodiment, an entirely software embodiment (including firmware, resident software, micro-code, etc.) or an embodiment combining software and hardware aspects. Embodiments may take the form of a computer program embodied in any medium having computer usable program code embodied in the medium. The embodiments may be provided as a computer program product, or software, that may include a machine-readable medium having stored thereon instructions, which may be used to program a computer system (or other electronic device(s)) to perform a process. A machine readable medium includes any mechanism for storing or transmitting information in a form (such as, software, processing application) readable by a machine (such as a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. Embodiments may further be embodied in an electrical, optical, acoustical or other form of propagated signal (e.g., carrier waves, infrared signals, digital signals, etc.), or wireline, wireless, or other communications medium. Further, it should be appreciated that the embodiments may take the form of hand calculations, and/or operator comparisons. To this end, the operator and/or engineer(s) may receive, manipulate, catalog and store the data from the insurance system 100 in order to perform tasks depicted in the plan management unit 116.

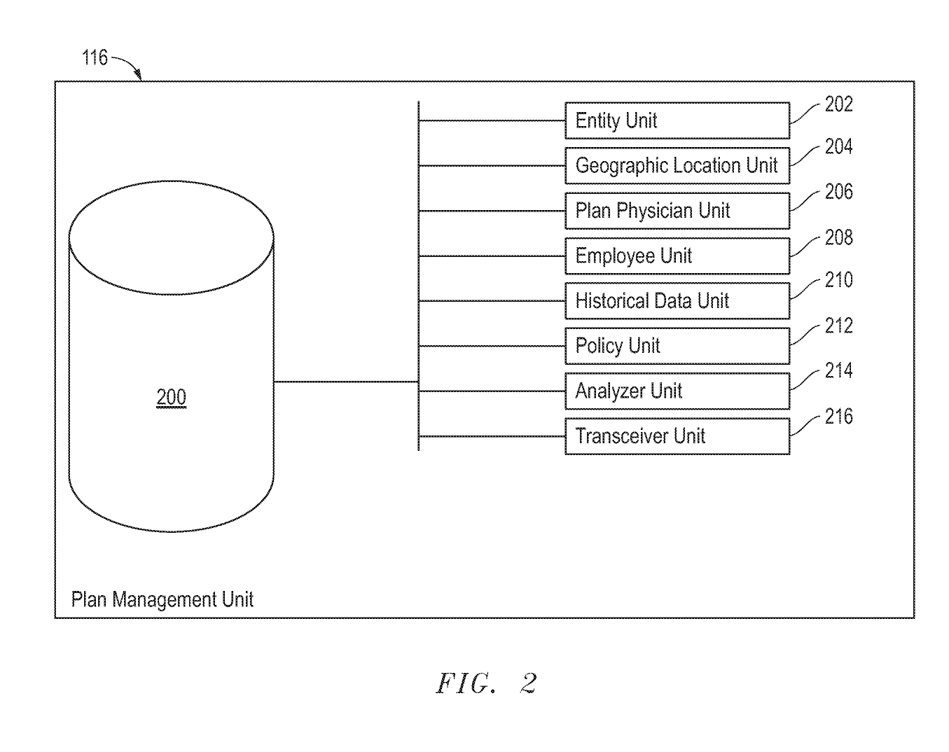

FIG. 2 depicts a block diagram of the plan management unit 116 according to some embodiments described herein. The plan management unit 116 may have a storage device 200, an entity unit 202, a geographic location unit 204, a plan physician unit 206, an employee unit 208, a historical data unit 210, a policy unit 212, an analyzer unit 214, and a transceiver 216.

The storage device 200 may be any conventional database or other storage device capable of storing data associated with the system 100, shown in FIG. 1. Such data may include, for example, geographic locations covered by the plan provider, entities covered by the plan provider, possible entities in each geographic location, current employees working for each of the entities, physicians located in each of the geographic regions, plan physicians, costs associated with the insurance plans, specialist located in each of the geographic region, employee information, historical data and the like. The analyzer unit 214 may be any conventional device, or system, for performing calculations, derivations, predictions, analysis, and interpolation, such as those described herein. The transceiver unit 216 may be any conventional communication device capable of passing signals (e.g., power, communication) to and from the plan management unit 116. The entity unit 202, a geographic location unit 204, a plan physician unit 206, an employee unit 208, a historical data unit 210, a policy unit 212, may be used to receive, collect and catalog data and/or to generate outputs as will be described further below.

The entity unit 202 may receive, collect, organize, and manipulate data regarding each entity 106 covered by the plan provider 104. Once an entity 106 has signed up as a customer of the plan provider 104, pertinent information regarding the entity may be gathered and stored on the entity unit 202. Examples of data stored on the entity unit 202 may include, but is not limited to, the number of employees 110 at the entity 106, the type of job each employee 110 performs, the type of work employees perform, the location of each worksite the entity 106 has, and the like. Such as historical loss data, number of treatments, number of days of disability, amounts charged and paid for workers' compensation medical services. The entity unit 202 may further be used to collect, organize, manipulate, and review medical network candidate credentials including but not limited to license certification, insurance coverage, and complaints.

The geographic location unit 206 may receive, collect, organize, and manipulate data regarding the geographic location 102, or potential geographic location, of any of the entities 106, plan physicians 108, employees 110 and/or specialists 112. The geographic location unit 206 may determine the size and scope of the geographic location 102 based on the location of the entity 106 and/or the employees 110 at the entity 106. The data regarding pertinent information about the geographic location may be stored in the geographic location unit 206 including, but not limited to, number of doctors, location of doctors, population size, health data, physical territorial maps, mailing address, and phone numbers, and the like. Further the geographic location unit may receive, collect, organize, and manipulate data regarding the exact territory of the servicing political subdivision. The workers' compensation medical policy area, or geographic location, may mirror the entities, or political subdivision, service area.

The plan physician unit 206 may receive, collect, organize, and manipulate data regarding the plan physicians 108 and/or potential plan physicians in any of the geographic locations described herein. For example, the plan physician unit 206 may store information including, but not limited to, the number of physicians in a geographic location 102, the price arrangement of plan physicians, the number of cases the plan physicians refer to specialists, the complaints filed against the physicians, and the like. Because the plan physicians 108 may be located within the geographic location 102 serviced by the entity 106, or political subdivision, the plan physician 108 has a vested interest in providing quality service to the entity 106. For example, if physician A lives in city A, physician A is more likely to provide discounts for city employees living in his city that he has his office in. This may hold true for any entity that the physician lives such as a school district, a county, and the like. The entity 106, or political subdivision, may select the plan physician instead of a typical insurance company. This allows the entity 106 to directly control the costs. If the entity 106, or political subdivision, does not like the plan physicians treatment or the employee, they can terminate that plan physician. In a typical network, the political subdivision could complain to the network administrator or insurance company, but would not be able to delete the physician or refuse to allow employees to access this doctor. This creates the check and balance between the entity 106, or the political subdivision, and the plan physician 108.

The employee unit 208 may receive, collect, organize, and manipulate data regarding the employees 110, past or present, of the entity 106. For example, the employee unit 208 may utilize data regarding the employees' medical history, place of residence, past medical coverage, past leave of absence claims, past workers compensation claims, and the like.

The historical data unit 210 may receive, collect, organize, and manipulate historical data regarding the plan physicians 108, the entities 106, the employees 110, the specialists 112, past employees, potential entities, potential physicians, insurance claims and the like. The historical data may be used to determine the historical patterns of the employees, the physicians, the entities and the like. The historical data may be used to provide a more efficient and cost effective medical coverage plans.

The policy unit 212 may receive, collect, organize, and manipulate data from the entity unit 202, the geographic location unit 204, the plan physician unit 206, the employee unit 208, and/or the historical data unit 210, in order to maximize the efficiency of the medical coverage plans for each of the entities 106. For example, the policy unit 212 may determine the geographic location of a new entity 106 that is requesting a workers' compensation medical coverage plan. The geographic location 102 may be based on the location of the entity 106 and/or the location of the majority of the employees 110 of the entity 106. The policy unit 212 may then determine one or more suitable plan physicians 108. The plan physicians 108 may be picked based on their location relative to the geographic location 102. Further, the plan physicians may be selected based on any number of factors including, but not limited to, the type of practice the plan physician 108 have, the type of work the employees 110 typically perform, the number of workers compensation claims the plan physician has approved in the past, the cost of the plan physician, the discount the physician is willing to give the, hours of operation, length of service in the community the like. The policy unit 212 may then supply details of one or more medical coverage plans based on any number of plan physicians 108. For example, the policy unit 212 may provide multiple coverage plans based on a selection of multiple plan physicians 108. The entity 106 may then select the type of medical coverage plan or plans they want to offer to their employees 110.

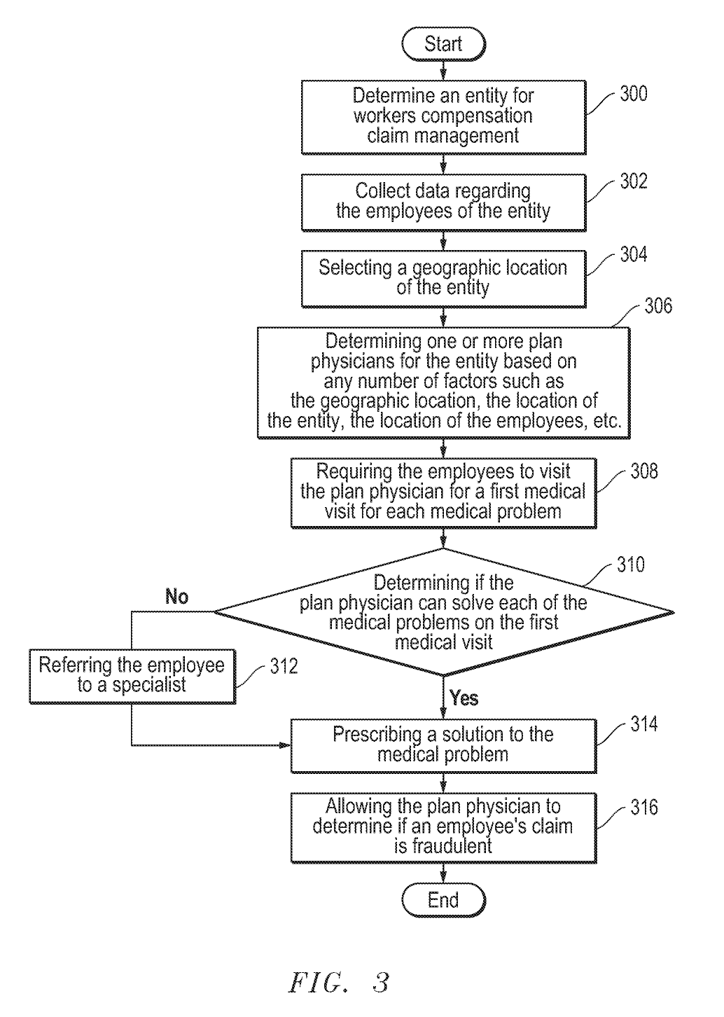

FIG. 3 is a flow chart depicting a method of providing a workers compensation claim management plan. The method begins at block 300 wherein an entity, or political subdivision, needing workers compensation claim management, a medical coverage plan, and/or a workers' compensation insurance policy, is determined. The entity may be any suitable entity including those described herein. The method continues at block 302 wherein data is collected regarding the employees of the entity. The method continues at block 304 wherein a geographic location for the entity is selected. The geographic location may be any suitable geographic location including those described herein. The geographic location may be determined based on any number of factors such as the location of the entity, the location of the employees and the like. The method continues at block 306 wherein a plan physician is determined for the medical coverage plan. The plan physician may be any suitable care provider including, but not limited to those described herein. The plan physician may be selected using any number of factors including, but not limited to, the location of the entity, the location of the employees, the type of work the employees perform, the type of physician needed, and the like.

The method continues at block 308 wherein the employees are required to visit the plan physician for each of their first medical visits for a medical problem. The method continues at block 310 wherein it is determined if the plan physician can solve, or treat, the medical problem on the first medical visit. If the plan physician cannot solve the problem, the method continues at block 312, wherein the plan physician refers the employee to a specialist. The specialist may then treat, or prescribe a solution to, the medical problem as shown at block 314. If the plan physician can treat the medical problem, the method continues at block 314. The method may continue at block 316 wherein the plan physician is allowed to determine if the employee's claim is fraudulent. The plan physician may act as a gate keeper to determine the extent of the employee's problem. If the employee has a history of trying to make fraudulent claims, the plan physician may act as a gate keeper to prevent the employee from the fraud. Having the limited number of plan physicians may prevent the employees from doctor shopping. Doctor shopping may involve the employee searching for a doctor that will allow them to make fraudulent claims.

While the embodiments are described with reference to various implementations and exploitations, it will be understood that these embodiments are illustrative and that the scope of the inventive subject matter is not limited to them. Many variations, modifications, additions and improvements are possible for example there may be three plan physicians.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A workers' compensation medical claim management system, comprising:
a plan provider;
an entity having at least two employees, wherein the employees work in a limited geographical location; and
a plan physician located proximate the limited geographical location and wherein the plan physician agrees with the entity to provide for service at a discounted rate and the employees are required to use the plan physician for initial treatment.

2. The system of claim 1, wherein the plan physician may refer the employee to one or more secondary care providers.

3. The system of claim 2, wherein the one or more secondary care providers are located proximate the limited geographical location.

4. The system of claim 1, wherein the plan physician is located within the limited geographic region.

5. The system of claim 1, wherein the limited geographic region is a county.

6. The system of claim 1, wherein the entity is a school district.

7. The system of claim 1, wherein the entity is a municipal government.

8. The system of claim 1, wherein the entity is a city government.

9. A method for providing a workers' compensation medical coverage plan for an entity having a plurality of employees, the method comprising:
determining a geographic location of the entity wherein the geographic location is an area wherein the entity and a majority of the employees for the entity are located;
selecting a plan physician in the geographic location;
providing the workers' compensation medical coverage plan to the employees; and
requiring the employees covered by the workers' compensation medical coverage plan to have a first medical visit to the plan physician for each medical problem.

10. The method of claim 9, further comprising having the plan physician determine the extent each medical problem.

11. The method of claim 10, further comprising having the plan physician prescribe a solution to at least one of each of the medical problems.

12. The method of claim 10, further comprising having the plan physician refer the employee to a specialist.

13. The method of claim 9, further comprising limiting the fee charged by the plan physician for the first medical visit.

14. The method of claim 9, further comprising collecting claim data on each of the employees.

15. The method of claim 14, wherein collecting claim data further comprised determining the number of workers compensation claims by the employee.

16. The method of claim 15, further comprising the plan physician monitoring the need for the employee to have a workers compensation claim.

17. The method of claim 9, wherein selecting a plan physician further comprises selecting two or more plan physicians.

18. The method of claim 9, wherein the entity is a government agency location.

19. The method of claim 18, wherein the geographic location is a county.
